(19) United States
(12) Patent Application Publication
(10) Pub. No.: US 2020/0013084 A1
(43) Pub. Date: Jan. 9, 2020

(54) SYSTEMS AND METHODS FOR CONVERTING SALES AND MARKETING OPPORTUNITIES

(71) Applicant: Data Trendz, LLC, Boulder, CO (US)

(72) Inventor: Kenneth Tola, Boulder, CO (US)

(21) Appl. No.: 16/503,054

(22) Filed: Jul. 3, 2019

Related U.S. Application Data
(60) Provisional application No. 62/693,563, filed on Jul. 3, 2018.

(51) Int. Cl. G06Q 30/02

(52) U.S. Cl. CPC G06Q 30/0251; G06Q 30/0201

(57) ABSTRACT

The present disclosure relates to systems and methods for enhanced advertising, marketing and sales campaigns based upon a customer audience and data associated therewith. In varying embodiments, the system includes a platform configured to access specific audience data, economic data, social data, news data, consumer browsing or on-line activity data, and process the audience data through a data management platform. The system may further comprise an advertising exchange for utilizing consumer data to match consumers with targeted advertisements and determine probability scoring based upon the consumer data.

### CROSS-REFERENCE TO RELATED APPLICATIONS

This application claims the benefit of U.S. Provisional Patent Application No. 62/693,563, filed on Jul. 3, 2018, the entirety of which is incorporated by reference herein.

### FIELD OF THE DISCLOSURE

The present disclosure relates generally to systems and methods for collecting and processing information transmitted over a network, and more specifically to such systems and methods as applied to sales, marketing and advertising content.

### BACKGROUND

Online marketing, advertising and sales platforms are known in the prior art. However, these prior art systems suffer from significant drawbacks, such as poor lead-generation and qualification processes, poor lag/response times, reactive (versus proactive) sales funnels, limited focus on programmatic purchasing, misidentification of prospective customers/products, over-reliance on generic and/or statistical purchasing behaviors, biased algorithms and/or incorrect logic, and other problems.

To illustrate, one issue in these prior art systems is an over-reliance on outmoded information, particularly when determining “good” from “bad” leads. Under prior art systems, a “good” lead is one wherein the person submitting the lead (form submission, chat, email, etc.) converts to an actual sale. These prior art systems rely on post-sales information to validate the quality of the leads coming in from different channels (including, by way of example, Google, Bing, YouTube, etc.) However, there is always some lag time between leads coming into a system and sales conversions, which can bias the qualification process and allow potential “good” leads to be mistakenly classified as “bad” leads, or alternatively cause the lead to be lost. Furthermore, as sales processes move further away from a pure online transaction or migrate into more complex interactions, the more lag time has a pronounced negative impact on sales-oriented optimization efforts. In the automotive industry, for instance, sales validation can take four months (or more) to achieve. As a result of these and other problems associated with prior art systems, it is estimated that over 70% of online leads are ineffective, costing online marketing and sales enterprises approximately $60 billion per year.

It would therefore be advantageous to provide a system and method that overcomes these shortcomings in the prior art and addresses the problems identified above. More specifically, it would be advantageous to provide systems and methods that focus on matching a larger number of attributes through data modeling and artificial intelligence (“AI”) oriented processes, which in turn provide for numerous dynamic attributes—from the weather to politics to gas prices—that may be utilized in qualifying the opportunity. A new level of historical sales data, inflated with these same dynamic attributes, can then be utilized to train the sales/marketing/advertising model in order to provide the most accurate forecasting possible.

In addition, it would be beneficial to consider more traditional attributes, such as demographic data, to create sophisticated profiles of “good” and “bad” leads, and/or profiles where leads can be scored in real time based on the dynamic information received by the system.

It would also be beneficial to apply one or more filters (dynamically) to the information received so that, as sales data becomes available, the model can be verified but the actual quality verification process can be achieved without reliance on post-mortem sales.

These and other advantages over the prior art will become known upon review of the Detailed Description and appended drawing figures.

### BRIEF DESCRIPTION OF THE DRAWINGS

The accompanying drawings, which are incorporated in and constitute a part of the specification, illustrate embodiments of the disclosure and together with the general description of the disclosure given above and the detailed description of the drawings given below, serve to explain the principles of the disclosure. In the accompanying drawings:

FIG. 1 illustrates a system for processing user data for a generic or anonymous user population;

FIG. 2 illustrates an embodiment of the present disclosure, wherein a system is provided for optimizing sales probability for a user population;

FIG. 3 illustrates further aspects of the embodiment illustrated in FIG. 2;

FIG. 4 illustrates a process diagram according to embodiments of the present disclosure;

FIG. 5 illustrates another process diagram according to embodiments of the present disclosure; and

FIG. 6 is a diagram showing a flow of information.

### SUMMARY OF THE INVENTION

The present disclosure includes systems configured to match user attributes, for sales, marketing or advertising to a user population, through data modeling and AI-oriented processes, which in turn may provide numerous dynamic attributes and improved data modeling. Methods for utilizing the aforementioned systems are also described.

In embodiments, the systems and methods described herein comprise a Data Management Platform (“DMP”) and a Demand-Side Platform(s) (“DSP”) for determining a Sales Probability Score for an audience. In certain embodiments, the audience is custom and specific to a particular buyer, while in other embodiments that audience is more generic.

In one aspect of the present disclosure, the system incorporates historical sales data, inflated with one or more dynamic user attributes, to train the sales/marketing/advertising model and provide even more enhanced forecasting.

In another aspect, the system is configured to analyze one or more traditional attributes, such as demographic data, to create sophisticated profiles, and thereby classify “good” and “bad” leads. Further, these profiles may be scored in real time based on the dynamic information received by the system.

In yet another aspect, the system is configured to apply one or more filters, dynamically, to the information received to implement an automated or semi-automated verification process without reliance on post-mortem sales.

Certain terms may appear in the following description and claims to refer to particular system components. As one skilled in the art will appreciate, individuals may refer to a component by different names. This document does not intend to distinguish between components that differ in name but not function.

In the following disclosure and in the claims, the terms “including” and “comprising” are used in an open-ended fashion, and thus should be interpreted to mean “including, but not limited to . . . .” Also, the term “couple” or “couples” is intended to mean either an indirect or direct connection. When used in a mechanical context, if a first component couples or is coupled to a second component, the connection between the components may be through a direct engagement of the two components, or through an indirect connection that is accomplished via other intermediate components, devices and/or connections. In addition, when used in an electrical context, if a first device couples to a second device, that connection may be through a direct electrical connection, or through an indirect electrical connection via other devices and connections. Connections can occur in a unidirectional, bidirectional or variable directional manner over all known means of network connectivity.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

As used herein, the term “user” refers to a uniquely identifiable construct within a system that is able to perform an action within the system. This action is not limited in scope and can include such things as create, read, update, delete (CRUD) options, transport, transformation, communications and so forth. For example, a “user” is not limited to a human being, but also includes processes, services, and other such subsystems and code that can be assigned unique identifiers. Thus, a user differs from a unique option such as a row identifier in a database table, which is unable to take any action on the system. In some instances, a user refers to a logical construct such as a user of a virtual machine running within the context of a physical device. In this instance, the virtual user is a version of the user mapping of the application hosting the virtual machine.

As used herein, the general term “device” refers to either a physical device (or group of physical devices) or a virtual machine or device. A physical device generally refers to the physical and software resources required to run an operating system and supporting software. A virtual machine generally refers to an emulation of a computer system, which may be carried out by a physical device or a collection of physical devices acting towards one logical purpose. Grid computing and clustered servers are examples of multiple devices working towards one logical purpose.

As used herein, the terms “user device” and “active user device” refer to the logical intersection of a device and a user. Users and devices may have a many-to-many relationship and thus multiple user devices may exist within a given device or for a given user at any one time.

As used herein, the term “platform” refers to a grouping of similar devices. Devices may be grouped based on the type of operating system used, the type of device itself (e.g., secured/unsecure; desktop/laptop/mobile; client/server; peer/super peer; or old/new), or another distinction that identifies devices in a given system either by its presence and variability among devices or by it lack of presence in some subset of devices. Thus, as used herein, the term “cross-platform” as in “cross-platform communication” refers to devices of two different platforms that communicate with one another; such a cross-platform system may be referred to as a hybrid system.

As used herein, the term “operation” or “performing an operation” refers to a packet-modifying operation such as encrypting the packet, replacing the packet with an alternate packet, deleting the packet, cloning the packet, replacing the packet with a packet pointer, and the like. Performing an operation on a packet may be restricted to a base datagram and may exclude to the modification of header fields.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “machine-readable media” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a flexible disk, hard disk, magnetic tape, or any other magnetic medium, magneto-optical medium, a CD-ROM, any other optical medium, a RAM, a PROM, an EPROM, a FLASH-EPROM, a solid state medium like a memory card, any other memory chip or cartridge, or any other medium from which a computer or like machine can read.

When the computer-readable media is configured as a database, it is to be understood that the database may be any type of database, such as relational, hierarchical, object-oriented, and/or the like. Accordingly, the invention is considered to include a tangible storage medium and prior art-recognized equivalents and successor media, in which the software implementations of the present invention are stored.

The terms “determine”, “calculate”, and “compute”, and variations thereof, as used herein, are used interchangeably and include any type of methodology, process, mathematical operation or technique.

The term “module” as used herein refers to any known or later developed hardware, software, firmware, machine engine, artificial intelligence, fuzzy logic, or combination of hardware and software that is capable of performing the functionality associated with that element.

The Summary is neither intended nor should it be construed as being representative of the full extent and scope of the present invention. The present invention is set forth in various levels of detail in the Summary as well as in the attached drawings and in the Detailed Description, and no limitation as to the scope of this disclosure is intended by either the inclusion or non-inclusion of elements, components, etc. in the Summary. Additional aspects of the present disclosure will become more readily apparent from the detailed description.

### DETAILED DESCRIPTION

The following disclosure is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the disclosure of any embodiment is meant only to be exemplary of that embodiment, and not intended to intimate that the scope of the disclosure, including the claims, is limited to that embodiment.

The foregoing applications are hereby incorporated by reference: U.S. patent application Ser. No. 16/397,998, filed Apr. 29, 2019; U.S. patent application Ser. No. 15/455,674, filed Feb. 28, 2017; U.S. patent application Ser. No. 14/318,880 filed Sep. 19, 2013; U.S. patent application Ser. No. 13/301,398 filed Nov. 21, 2011, now U.S. Pat. No. 8,566,443 issued Oct. 22, 2013; and, U.S. patent application Ser. No. 12/103,619 filed Apr. 15, 2008. The entire disclosures of these applications are hereby incorporated by reference in their entireties as if fully set forth herein.

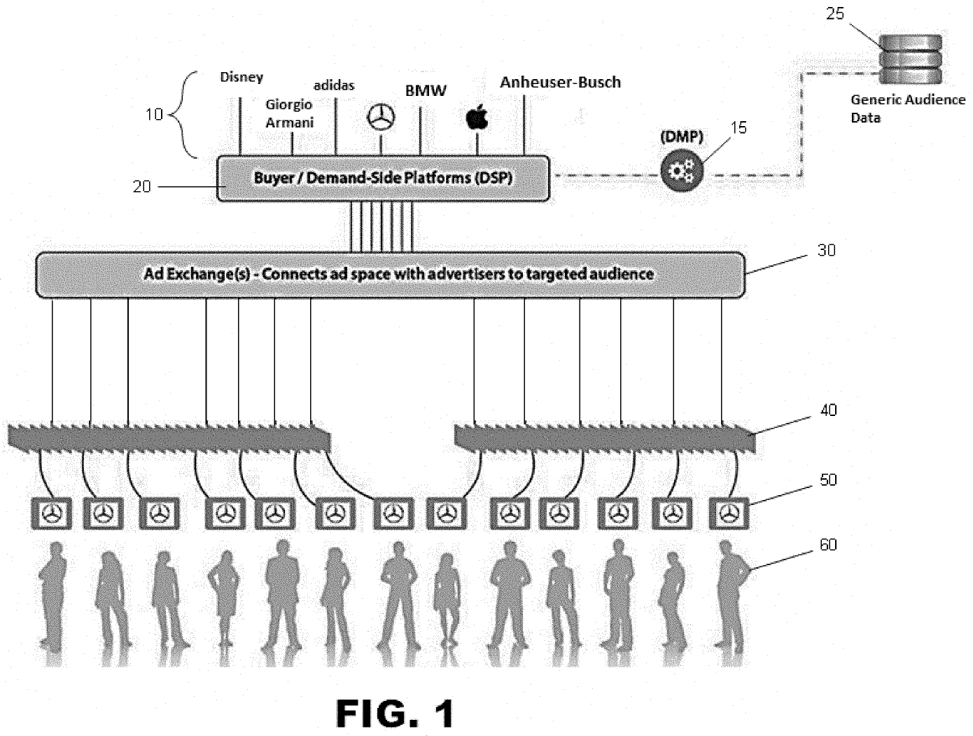

As illustrated in FIGS. 1-5, preferred embodiments of the present disclosure are shown. Referring to FIG. 1, a generic user population advertising/marketing system is shown. Here, the generic audience data 25 is provided to a DSP 20, which may be connected to a DMP 15, although is not utilized in every instance. The DSP 20 connects with an advertising exchange 30, which bridges between advertisers 10 (such as Mercedes Benz®) and the target audience 60 for the purpose of delivering advertisements 50 for products based upon potential leads. However, because of the shortcomings described above, the target audience 60 may receive advertisements 50 for products the generic internet population is generally interested in, but that specific consumers have little to no interest in.

In embodiments, the systems and methods further comprise a Marketing Integration Layer 40, which introduces additional data into the DSP 20, by way of example but not limitation, DoubleClick, Kenshoo, Omniture or Marin. The Marketing Integration Layer 40 preferably leverages a unique identifier (for a given conversion from the DSP 20) to apply a Sales Probability Score into a new numeric column in the DSP 20. In embodiments, the inserted Sales Probability Score is for a particular conversion. This in turn permits the DSP's optimization algorithms to be weighted towards the highest probability of a sale.

In embodiments, the DMP 15 may be connected or otherwise configured to receive data from other DMPs 15, or alternatively from other platforms, such as analytic platforms or dynamic service providers. The DMP 15 may then provide data to the DSP(s) 20, which in turn may provide the data to one or more advertising exchanges 30.

The system may support multiple data sources/structures, including by way of example, MySQL, MS SQL Server, Rabbit and Zero MQ. The system can also be configured to share information across multiple servers and share data by local port forwarding. Similarly, data can be viewed and analyzed across a highly distributed system, and exemplary records for the systems and methods described herein may contain complete, roundtrip transmission data, including complete DOM object, complete HTTP packages, data types, as well as any dynamically submitted information.

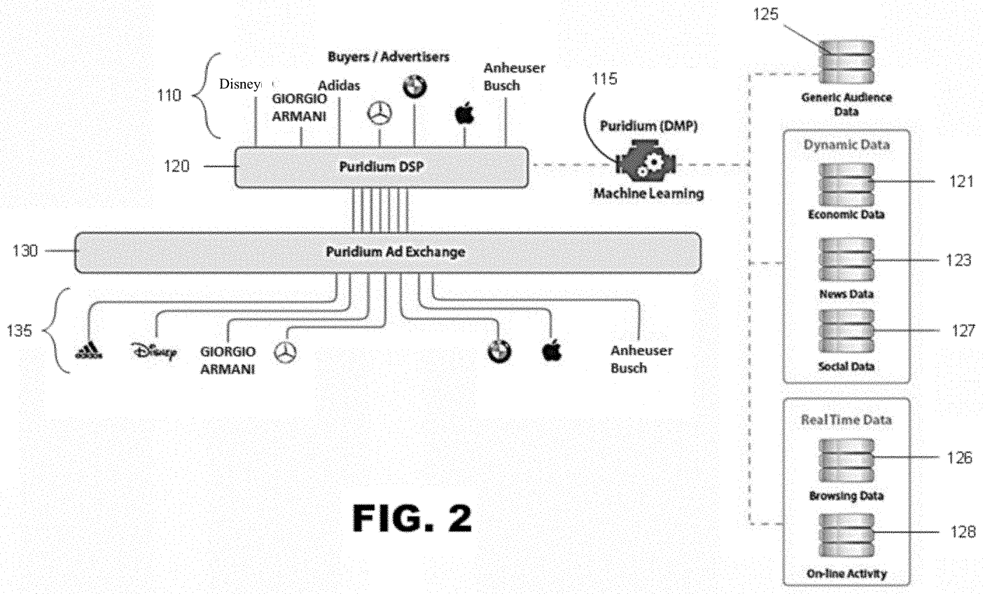

Referring now to FIG. 2, a system for determining a Sales Probability Score for an audience is shown. In embodiments, the audience of FIG. 2 is customizable and specific to a particular buyer or class of buyers. As shown in FIG. 2, the advertisers 110 may receive real-time feedback, via the DMP 115, on consumers they are trying to reach. The real time data may be categorized according to data type, including browsing data 126 and/or on-line activity data 128. The data sources may include generic audience data 125 but preferably are also dynamic to include different data sets, such as economic data 121, news data 123, social data 127, demographic data, etc. The level of data, in conjunction with the Puridium DSP 120, permits creation of a specific buyer Profile, as described in greater detail below, which is preferably used to direct advertising buys via the Puridium Advertising Exchange 130. This allows the advertisers 110 to buy ad positions 135 through the Puridium Advertising Exchange 130 more effectively, and truly target the consumer Profiles they desire. Sales Probability Scores may be determined for unique consumers and matched to the advertiser 110 corresponding to that Profile. Additionally, this allows advertisers 110 to buy and place advertisements 135 according to probability score, as opposed to conglomerated, biased, or inflated generic consumer data.

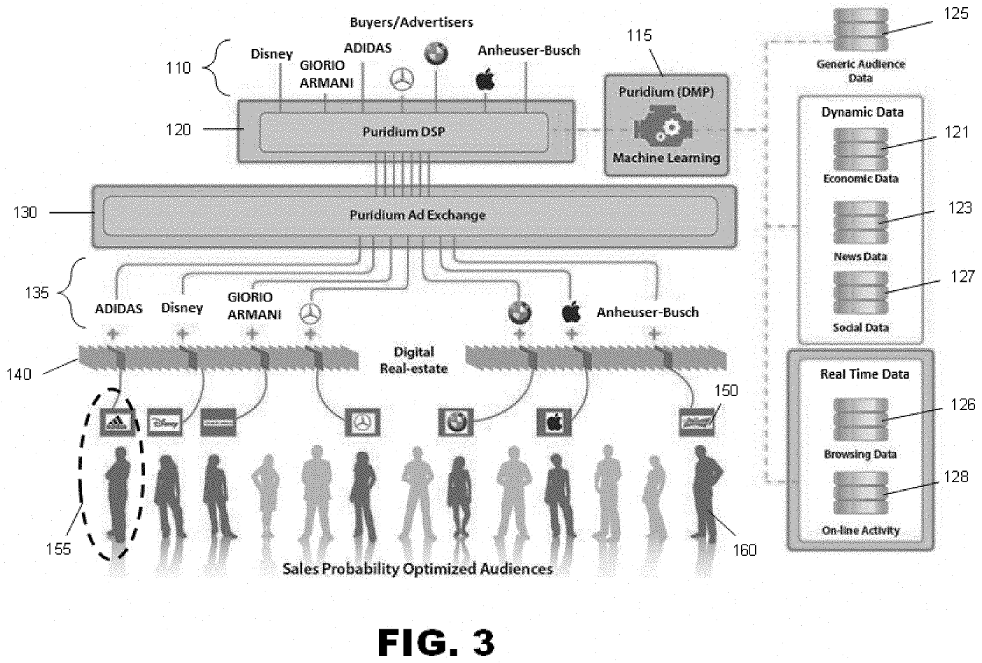

Referring now to FIGS. 2 and 3, the system preferably comprises as Puridium Data Management Platform or, as referred to herein, the DMP 115. The DMP 115 preferably comprises machine learning, multivariate correlation capabilities, and is configured to provide a weighted purchase coefficient to analyze and determine the highest probability of a sale and thereby the most effective advertisement 150. The DMP 115 is preferably capable of communicating with existing advertising management systems and extracting real-time 126, 128 and dynamic data 121, 123, 127 to create purchaser Profiles, which are described in greater detail below. By utilizing custom audiences, the system and method both decreases lead cost and increases sales.

The Puridium DSP 120 is preferably configured to obtain data from the DMP 115 in real-time, and instantly obtain the benefit of both cookieless tracking and Sales-Oriented optimization. In addition, the real-time tracking nature of the system described above can be leveraged to provide dynamic reporting that shows browsing, visits and conversions as they occur. This approach to tracking will generate an enhanced method of website activity monitoring.

The Puridium DSP 120 may also be configured to take advantage of a feature referred to as Puridium Dynamic Audiences. This feature enables the Puridium DSP 120 to target the best possible visitor and identify consumer matches 155 at any moment in time. By back-ending services such as Facebook, integration slowdowns may be eliminated to populate the custom audience 160. Further, Puridium DSP 120 analytics have complete control over the rules defining audience 160 members. These features may be combined with a Puridium Advertising Exchange 130 or custom exchange configured to take into account demographic or other attributes to obtain an unrestricted Sales Probability Score. For example, if the existing exchanges do not accommodate weather or politics or other attributes, the Puridium Advertising Exchange 130 can modify audiences, attributes of interest, or other rules from the DSP 120 rules engine to realize a more dynamic and complex scoring.

In this paradigm, the systems and methods described above provide a complete platform—from DMP 115 to DSP 120 to the Exchange 130—instead of dealing with specific slot requests and partial page statistics as with prior art systems. The associated Profiles may contain complex attribute matrices that comprise demographic and dynamic information from a range of possible sources.

Users of the Puridium DSP 120 can create complex rules for implementation through the DSP rules engine, or leverage the Puridium analytics and AI to go after targets never before achievable. All of these features are preferably nested within the overall goal of a Sales-Oriented marketing effort.

One of the benefits obtained through use of the Exchange 130 is to move from the matching paradigm found in current exchanges to an AI-oriented system wherein probability of sales drives advertising placements 150 within the Exchange 130. By utilizing complex profile constructs, machine algorithms can be leveraged that statistically break down Profiles and compare probabilities of sales to determine the best overall placements and, eventually, consumer matches 155. Given the performance of current efforts, these complex probability calculations can occur in milliseconds.

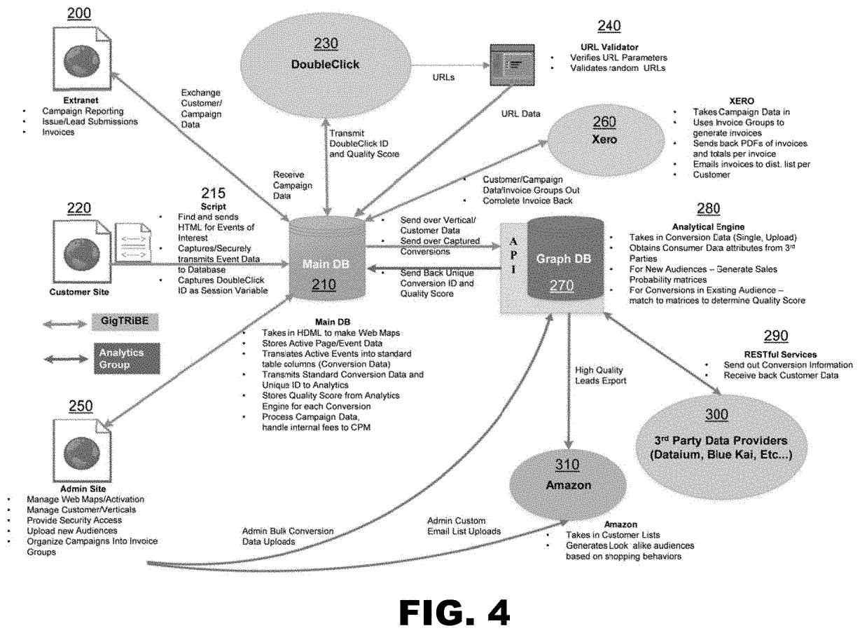

Referring now to FIG. 4, the Puridium platform is depicted in a diagrammatic format. Certain features of the platform have been described above. In addition, the platform may comprise one or more Extranet(s) 200 to support DSP 120 function, report overlays on external DSPs 120, invoicing, and/or manual lead scoring. The platform may also comprise an Administrative Site 250 which enables administrators to manage customers, upload historical sales data/external DMP 115 data and control invoicing. The platform may further comprise a “Xero” module 260, which preferably is configured to process automated invoicing, and a DMP 115 tracking database, which may serve as the data warehouse for the Puridium DMP 115.

In embodiments, a Puridium analytics engine 280 is also provided with the system and method described above. The approach leveraged by Puridium starts with a multivariate analysis of variance (MANOVA) model, wherein various datasets are leveraged to build a unique profile of successful and unsuccessful past sales. Unlike other efforts in the industry, Puridium analytics 280 leverages both Sales and Time to provide a dynamic profile that can accommodate fluid predictive models. Puridium analytics 280 then extends these predictive models using AI and/or neural networks that extend regression and clustering methods into a nonlinear, multivariate model.

Puridium analytics 280 starts with a multivariate approach in order to generate an initial profile. However, Puridium analytics 280 creates both a negative and positive profile, which examines both single variables and variable interactions, which can be extremely complex. Puridium analytics 280 may also be configured to leverage time as another dependent variable and thus extends its MANOVA model into a regression analysis. Since not all variables support time, a clustering effort is also leveraged in order to accommodate both static and dynamic independent variables.

The MANOVA analysis is complemented by a “Random Forest” classifier which is used to quantify the degree to which each attribute contributes to Profiles creation. From this ranking process, Puridium analytics 280 can derive weights which inform the final weighting scheme applied to Profile attributes. Both MANOVA and Random Forest classification are preferably continually performed as new sales data enter the system. Puridium analytics 280 tracks these feature fluctuations over time which yields yet additional and novel insight into the relationships between external dynamic factors and attribute relevance, and how those relationships influence conversions and sales probabilities.

Puridium analytics 280 may also comprise Predictive Modeling with temporal and sequential variables. In these embodiments, static attributes are generally dominant in audience modeling and performance analyses, leading to rigid predictive models that ignore the effects of influential dynamic variables. Such dynamic variable may include time, weather, political atmosphere, etc. Including the dynamic variable of time enables Puridium analytics' predictive models to account for cyclical variation across multiple time intervals (intraday, weekly, monthly, yearly, etc.). In turn, Sales Probability Scores and audience profile models benefit from a continuously retrained recurrent neural network (RNN) which, unlike traditional neural networks, produces predictive models that account for sequential and temporal variation in audience behavior. The RNN(s) may further leverage Long Short-Term Memory (LSTM) cells in their hidden layers, allowing the system of this embodiment to be sensitive to patterns that recur infrequently over longer time durations. These deeply layered prediction engines enable the system to produce not only near real-time sales probability estimates, but to predict how those estimates might trend in the next hour, day, week, etc., or how they might respond in the event of a particularly disruptive political, social, or natural event.

Puridium analytics 280 may also encompass augmenting audiences Profiles via textual analysis of browsing history. Research has shown that audience segmentation and corresponding audience labeling/targeting can be improved by natural language analysis of the content of URLs visited by a particular target. Each word of content may be mapped to a vector, and utilizing a process called Word Embedding, which replaces each word with a low-dimensional vector representation, Puridium may assign numeric structures to words and then weight all words using a variation of Term Frequency Inverse Document Frequency (TF-IDF). This approach allows all URLs to be collapsed into a single number or vector and mapped to a low-dimensional space where clustering occurs. The result is a discrete set of numeric identifiers representing standard visitor profiles. As new potential targets enter into the system and provide an initial browsing history, each target is assigned an initial value representing their web browsing profile, one of many characteristics used by Puridium to augment the attribute-based Profile for each individual target. The system preferably comprises a URL validator 240 provided to verify URL parameters and validate random URLs.

As described above, the system may comprise a Marketing Integration Layer 40 that includes DoubleClick 230. DoubleClick 230 may receive a DoubleClick ID and Quality Score from the Main Database 210, and pass URLs to the URL validator 240 for validation. The Main Database 210 provides a number of important functions as depicted in FIG. 4, including sending and receiving customer data, conversion ID and Quality Score to/from the API Graph Database 270. The API Database 270 may in turn provide data to Third Party data providers 300 or export high quality leads to, for example, Amazon 310 or other ecommerce site, which may receive further information from the Admin Site 250.

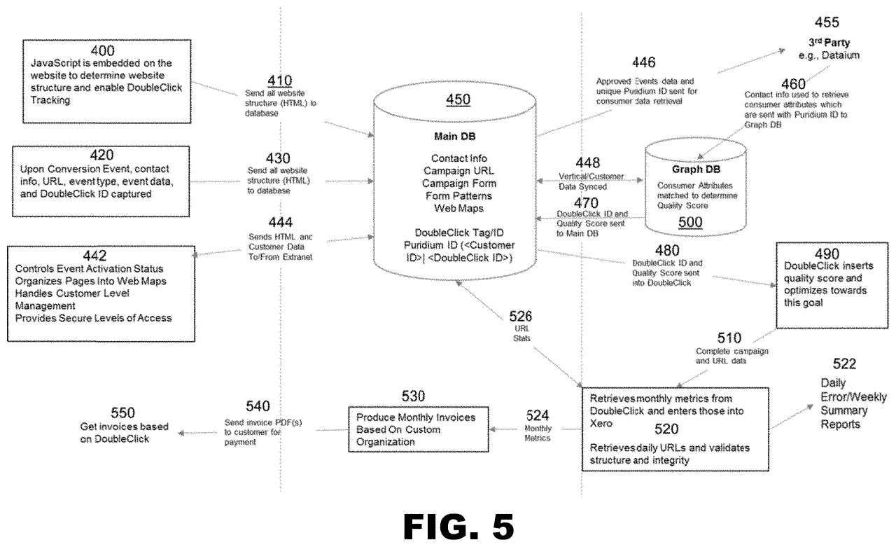

Methods of collecting and processing information transmitted over a network, such as sales, marketing and advertising content, are also disclosed herein. Referring in detail to FIG. 5, a method comprising several steps is shown. Here, although the steps are described sequentially, it is to be understood that the sequence of these steps is not critical to the novelty of the methods described herein. In addition, while several components are depicted graphically in FIG. 5 (such as a database), it is expressly understood that equivalent structures and components may be substituted without deviating from the novel aspects of this disclosure. Certain steps may be eliminated from FIG. 5 without departing from the spirit of the present disclosure.

In a preferred embodiment, the method comprises the step of embedding JavaScript or an equivalent application on a website 400. This step 400 enables tracking of activity, such as through DoubleClick or equivalent programming, and allows the system to determine the website's structure. Another step is to send the website structure 410 to a central database 450. In embodiments, the structure may be in html or xml format. Once tracking is enabled, and upon the occurrence of a conversion event, information such as contact details, URL, event type, event data and an ID (such as a DoubleClick ID) may be captured 420 and, in a preferred embodiment, communicated to the central database 450 in another step 430. An administrator may further control event activation, ensure secure access, manage customer level events and organize website pages 442. This information and activity of the administrator may be communicated 444 to the central database 450.

The central database 450 may therefore contain all contact information, advertising campaign URLs, campaign forms, patterns, maps, etc. for facilitating the method described herein. The central database 450 permits approved event data and a unique Puridium ID to be delivered 446 to a third party 455 such as Dataium, which then may be used to retrieve consumer attributes 460 to facilitate determination of probability scores, as described above. A graph database 500 preferably is used to receive the consumer attributes 460 and perform matching to determine a preliminary quality score. The graph database and the central database may periodically synchronize 448 to ensure customer and/or vertical data is consistent during this process. Once determined, the preliminary quality score and the DoubleClick ID are sent 470 to the central database 450. Once this paired information is received, the data may be sent 480 to DoubleClick (or equivalent application), and the preliminary quality score is updated into the system for optimizing the campaign's goals. Complete campaign and URL data may then be delivered 510 to a DoubleClick Manager 520. The manager 520 may retrieve monthly or other periodic metrics and convey the metrics 524 to, by way of example but not limitation, Xero 530. The Manager 520 preferably retrieves URL stats 526 from the central database 450 and may further generate error and summary reports on a daily, weekly or monthly basis. Xero 530 produces monthly invoices based upon the custom organizational structure, which may then be sent to the customer 540 for payment. Invoices may further be received through DoubleClick 550.

The method described above continuously import dynamic information in order to support predictive modeling, which may be captured and simplified into conceptual Profiles. These Profiles contain a large number of statistically-significant independent variables with weighted ranges that are valid for a given moment in time. These Profiles are collectively leveraged to weight prospective audience members for a defined segment, with the result being a Sales Probability Score for a sale for each member for a target audience (e.g. a new car, house, etc.) Audiences are then presented in the Puridium DSP with a baseline probability score being used to eliminate prospects with no significant sales probabilities.

For each audience segment, nodes are established that represent the Independent Variables from the regression analysis. These nodes are continuously being modified by the regression analysis, and may further become modified by ongoing lead scoring. The continuous lead scoring determines the probability of a sale for an incoming lead preferably after that lead has been inflated to a complete Profile.

As the incoming lead's Sales Probability Score is determined, the independent variable values are captured and used to adjust the weighting of each independent variable. The amount of adjustment is determined through, for example, machine learning, and is subject to time and market segment interactions.

In addition, postmortem sales data is leveraged to verify and adjust (when needed) the predictive models. FIG. 6 is a diagram that depicts information flow.

In embodiments, the system and method operate via a network, such as the Internet, having a broad range of differing network locations. Network locations may include network servers, website servers, personal computers, mobile devices such as phones capable of accessing the Internet and a host of other network capable devices. However, the systems and methods described herein also provide functionality and utility to other networks, such as private intranets, where the range of network locations may be more homogenous than that found on the Internet. It is to be expressly understood that implementation of the systems and methods described above may be made on virtually any type of network, connecting virtually any type of network location to virtually any other type of network location.

In embodiments, the system and methods may be associated with a data collection system configurable to communicate with an originator system, which may act in the role of a responding system. The information sent from the originator system can be stored for subsequent use, then utilized to generate a request based on the context of the originating system request. The data collection system then acts in the role of the originator system and submits a request to the responding system via a network. In these embodiments, the originating message (request) includes a first Universal Resource Indicator (URI) that can be used to determine the intermediate server, including but not limited to, a web server or a proxy server. The first URI can be used by the intermediate server to determine a second URI, the responding system URI, which may be based in part on dynamic URI mappings. The responding system can then return a response to the data collection system and this response can be both stored and used to generate a response back to the originator system. This information can then be utilized to support advanced user interaction analytics with monitored network-enabled sites.

In a preferred embodiment, the system is configured to collect all information exchanged between the originator system and the responding system. In this manner, the system may serve as an intermediate web server and processes all requests for information between the originator system and the responding system. In turn, all user actions in-page are relayed back to the system using a system URI. In one embodiment of the disclosure, the network comprises the Internet in either a wired, wireless cellular or other medium. In another embodiment of the disclosure, the network is selected from the group comprising a local area network (LAN) and a wide area network (WAN). The disclosure is not limited to implementation in any specific network configuration. Instead, it will find application in any type of system comprising interconnected computers or other smart device configured to communicate with each other using electronically transmitted messages.

The data collection system receives the request from the originator system, and processes the request to determine the destination URI, which may be based in part on dynamic URI mappings. The data collection system then modifies or creates a new message based on the original request, and sends the new request to the responding system. The data collection system processes the response from the responding system, and modifies links and other data to point to the data collection system. As a user browses between webpages or websites, the data collection system continues to act as an intermediary as messages flow between the originator system and one or more responding systems to allow continued message processing and message flow control.

In this detailed description of the preferred embodiments, illustrative embodiments of the systems and methods are described and set forth. These illustrations are not intended to be exhaustive or limiting, but rather to highlight some of the features, benefits and advantages associated with various embodiments of the technology. While various embodiment of the present disclosure have been described in detail, it is apparent that modifications and alterations of those embodiments will occur to those skilled in the art. However, it is to be expressly understood that such modifications and alterations are within the scope and spirit of the present disclosure, as set forth in the following claims.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the present disclosure has included description of one or more embodiments and certain variations and modifications, other variations and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system for optimizing sales probability, comprising:
a demand-side platform;
a data management platform in communication with the demand-side platform and one or more databases containing consumer data;
an advertising exchange platform in communication with the demand-side platform and one or more members of a target audience, the advertising exchange configured to deliver advertisements to the one or more members of a target audience based upon a sales probability score;
wherein the sales probability score is determined by the data management platform by creating a custom consumer profile, the custom consumer profile in turn is created from independent variables determined from the consumer data obtained from the one or more databases and a weighting factor applied to each of the independent variables;
wherein the sales probability score is determined by a processor configured to execute an operating system and one or more applications contained on specific computational machinery.

2. The system of claim 1 further comprising a rules engine for implementing rules for determining the sales probability score.

3. The system of claim 1, wherein the data management platform receives metrics from the implementation of advertisements placed through the advertising exchange platform and updates the sales probability score from the metrics received.

4. The system of claim 1 further comprising a graph database for determining relevant consumer attributes for use in determining the sales probability score, the graph database in communication with the data management platform.

5. The system of claim 4 further comprising a third-party database for identifying consumer attributes and associating the consumer attributes with a unique ID provided by the data management platform.

6. The system of claim 1, wherein the consumer data is selected from the list consisting of audience-related data, economic data, social data, news data, consumer browsing data and on-line activity data.

7. The system of claim 1, wherein the data management platform further comprises an engine for performing regression analysis.

8. The system of claim 1, wherein the data management platform further comprises an analytics engine configured to perform a multivariate analysis of variance model, and wherein the custom consumer profile is updated to reflect successful and unsuccessful past sales.

9. The system of claim 8, wherein the analytics engine is configured to consider both past sales and associated time of past sales in updating the custom consumer profile.

10. The system of claim 8, wherein the analytics engine is configured to perform predictive modeling utilizing both temporal and sequential variables.
